(19) United States
(12) Patent Application Publication
(10) Pub. No.: US 2001/0036827 A1
(43) Pub. Date: Nov. 1, 2001

(54) Procedure for down loading cell information to mobiles in idle mode

(75) Inventors: Peter Hans Edlund, Tumba (SE); Mattias Hagberg, Solna (SE); Walter Gerhard Alois Muller, Upplands Vasby (SE); Yngve Bengt Persson, Djursholm (SE)

Correspondence Address: James O. Skarsten, Jenkens & Gilchrist, P.C., 3200 Fountain Place, 1445 Ross Avenue, Dallas, TX, 75202-2799, US

(73) Assignee: Telefonaktiebolaget L M Ericsson (pub1)

(21) Appl. No.: 09/814,270

(22) Filed: Mar. 21, 2001

Related U.S. Application Data
(60) Provisional application No. 60/192,777, filed on Mar. 28, 2000.

(51) Int. Cl. H04Q 7/20

(52) U.S. Cl. 455/432; 455/456; 455/517; 455/525

(57) ABSTRACT

In a telecommunications network wherein a location area contains GSM cells having adjacent or neighboring UTMS cells, a dedicated procedure is employed to download information about a UTMS cell to a mobile station. After entering the location area, the mobile is notified of the presence of the UTMS cell. In response to the notice, the mobile is operated to acquire specified information about the UTMS cell from the network, such as frequency and scrambling code combinations, radio access bearer configuration, and information pertaining to intersystem cell selection.

### CROSS-REFERENCE TO RELATED APPLICATION

This Application for Patent claims the benefit of priority from, and hereby incorporates by reference the entire disclosure of, co-pending U.S. Provisional Application for Patent Serial No. 60/192,777, filed Mar. 28, 2000.

### BACKGROUND OF THE INVENTION

The invention disclosed and claimed herein generally pertains to an improved procedure for downloading or broadcasting system information to a mobile phone or mobile station (MS), also referred to in the art as a User Equipment (“UE”). More particularly, the invention pertains to a procedure of the above type wherein the information to be downloaded is directed to mobile stations, or mobiles, which have dual mode or multimode capability, and can communicate with two or more systems, such as the Global System for Mobile communication (“GSM”) and the Universal Mobile Telecommunications System (“UTMS”). Even more particularly, the invention pertains to a procedure of the above type wherein new information needs to be downloaded to the User Equipment to prepare for handover and cell reselection from GSM to UMTS.

As is well known in the art in connection with a GSM network, system information messages, i.e. data about the network that its mobiles need in order to communicate with the network, are continuously sent on the Broadcast Control Channel (“BCCH”) by the Base Transceiver Station (“BTS”) to all idle mobiles in a GSM cell. The network needs to know where the mobile or UE is located for a roaming mobile subscriber. Thus, in order to keep the network up-to-date with the subscriber's location the UE informs the system, by means of the standard GSM location updating procedure, whenever it changes location area. In common conventional practice, the BCCH is used to provide broadcast information to mobiles. Such information indicates, among other things, neighboring cell information on which the mobiles are to perform measurements.

Some mobile stations have multimode capability, such as dual mode mobiles which can communicate with both the GSM and the UMTS systems. When such dual mode mobiles enter a GMS Location Area which has UMTS neighbors (in some network configurations a Location Area may also contain both GSM and UMTS cells), a considerable amount of data must be downloaded to the dual mode mobiles, in idle mode. Such data can include neighboring cell frequencies and scrambling codes, measurement related information, and intersystem cell reselection parameters. Unfortunately, there is a lack of space on BCCH for this new information, and a longer scheduling period may become necessary. Downloading broadcast information may also effect single mode mobiles decoding only the 2G part, negatively such that the scheduling period of relevant 2G information will increase.

In one approach to insure that a dual mode mobile receives all necessary information about UMTS cells in a Location Area, such information is continuously downloaded to all mobiles within cell areas having UMTS neighboring cells. However, when there are few or no dual mode capable mobiles within the cell area, such effort will be mostly or entirely wasted. Downloading UMTS cell information is of no benefit to single mode mobiles, which can communicate only with GSM cells. Accordingly, it would be desirable to provide an alternative approach which uses dedicated messages, that is, which supplies UMTS information to dual mode mobiles only. In developing such an alternative, it is necessary to consider the issues of what information a dual mode UE is to receive from the network; how it is to get the information; and when it is to measure UMTS neighboring cells.

As is known by those of skill in the art, a mobile is in idle mode when it is roaming and switched on, in a non-active mode. As is further well know, a mobile engages in cell measurement by scanning different radio frequencies in a GSM system, and determines the relative signal strengths thereof. Such information enables the mobile to determine the location of nearby cells, and to generate lists of information relating thereto.

### SUMMARY OF THE INVENTION

In the invention, it is proposed to use only one or a few bits on BCCH, in combination with dedicated messages to download some or the complete UMTS information to dual or multimode mobiles only. In one embodiment, in combination with Mobility Management (MM) specific procedures wherein dedicated messages are sent only to dual mode mobiles during short time periods, a single bit is broadcast on BCCH to idle dual mode mobiles, in order to trigger measurement of UMTS neighboring cells. It will be readily apparent that this embodiment will have negligible impact on the performance of GSM only mobiles. It is anticipated that this and other embodiments of the invention will provide important benefits and advantages, including reduced power consumption in idle mode, and reuse of existing GSM system information. Moreover, BCCH bits will not be wasted when there are no UMTS capable mobiles in the GSM cell, and an operator may be able to accomplish forced roaming of individual mobiles.

Generally, the invention is directed to a telecommunications network associated with a number of first cells in a location area, wherein each first cell is associated with a first communication system, a given first cell has a neighboring second cell associated with a second communication system, and both multimode and single mode mobile stations are disposed to enter and move through the location area into proximate relationship with the given first cell. In such network, a method is provided for downloading information to a selected multimode mobile station comprising the step of providing notice of the second cell to the selected mobile, after it enters the location area. The method further comprises withholding such notice from single mode mobile stations entering the location area. In response to the notice, the selected mobile station is operated to acquire specified information pertaining to the second cell. In a useful embodiment, the first and second communication systems comprise the GSM and UTMS systems, respectively.

In one embodiment of the invention, the notification step comprises downloading of a flag to the selected mobile, the flag preferably comprising a single bit transmitted to the selected mobile by means of a BCCH carrier. This flag will also be read by single mode mobiles but not understood.

In another useful embodiment, the notification step comprises downloading a list of first cells to the selected mobile station, and identifying each of the first cells on the list which has a neighboring second cell. The list is usefully downloaded to the selected mobile in connection with a standard location updating procedure, which is commenced when the selected mobile enters the location area. First embodiment: UMTS frequency has already been downloaded at LAU (Location Area UMTS). Another embodiment: Reception of UMTS flag shall trigger MM specific procedure to download UMTS frequency plus scrambling codes.

### BRIEF DESCRIPTION OF THE DRAWINGS

FIG. 1 is a schematic diagram depicting a Service Area and its constituent Location Areas.

FIG. 2 is a schematic diagram depicting movement of a mobile station (“MS”) through a Location Area containing both GSM and UMTS cells, or GSM cells with UMTS neighbors.

### DETAILED DESCRIPTION

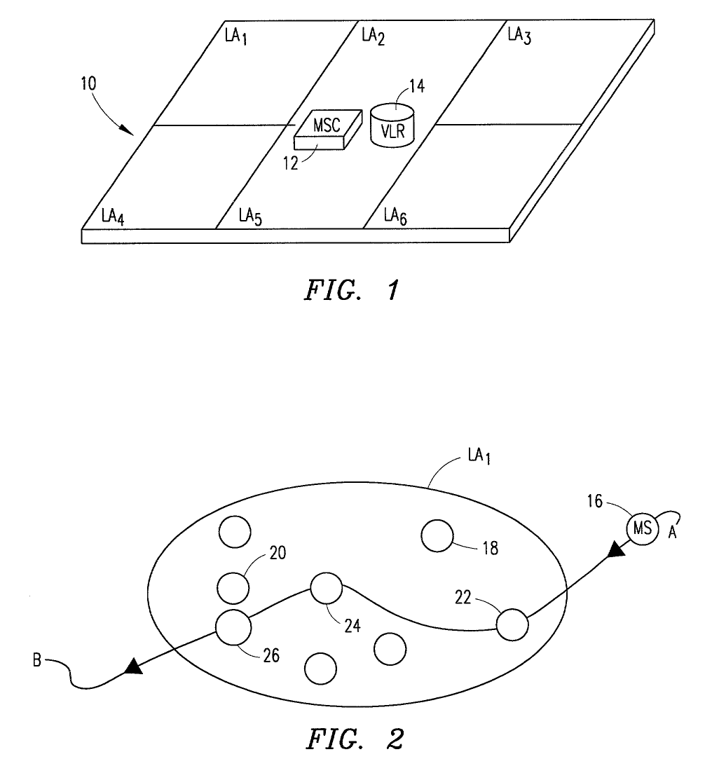

As is well known in the art, a GSM/PLMN (“Public Land Mobile Network”) service area comprises one or several Service Areas, each served by a Mobile Switching Center (“MSC”) and a Visitor Location Register (“VLR”). Referring to FIG. 1, there is shown a MSC/VLR Service Area 10, which is provided with MSC 12 and VLR 14, and is divided into a number of Location Areas LA₁-LA₆. A Location Area is a part of the MSC/VLR Service Area in which a mobile station may move freely, without updating location information to the MSC/VLR exchange. A Location Area is the area where a paging message is broadcast in order to find the called mobile station. A Location Area can have several cells and depends on one or more base station controllers, but it belongs to only one MSC/VLR.

The above information is disclosed, for example, in a document entitled, “CME 20 System Survey Training Document” pps. 28-29, copyrighted 1996 by Ericsson Radio Systems AB.

When a dual mode mobile station or UE enters a Location Area (“LA”), it performs standard GSM location updating with respect to the PLMN. In responding to location updating, the network may, as an addition to the updating procedure and in accordance with an embodiment of the invention, download UMTS neighboring cell information for the Location Area to the dual mode mobile. The mobile will use this information, as it moves through the GSM Location Area, for monitoring and measurements of the UMTS cells located therein. Clearly, it would be especially useful for the mobile to receive this information at normal Location Area Update, when the mobile first enters a LA that has UMTS neighbors. Moreover, frequency and scrambling code combinations, together with intersystem cell reselection parameters for all UMTS neighboring cells within the LA, are likewise downloaded to the UEs with use of multimode specific procedures. This information is stored as a list in the UE during its visit in the LA. Further, information received by the mobile could include pre-information about radio access bearer configuration of target cells, in care of handover, and information about the service capability of UMTS cells which may be used for Intersystem cell selection.

It is to be emphasized that the above embodiment is multimode specific. That is, dual mode mobiles would receive the information pertaining to UMTS cells, but single mode mobiles, which are able to communicate with the GSM system but not with UTMS, would not receive it. Thus, wasted broadcast of the additional information would be eliminated.

Referring to FIG. 2, there is shown a mobile station 16 moving from point A to point B through Location Area LA₁ of FIG. 1, which contains UMTS cells such as cells 18 and 20 and a number of GSM cells such as cells 22-26. At point A the mobile station 16 is camped on a GSM cell. While moving through the GSM Location Area LA₁ the mobile station 16 camps on GSM cells 22, 24 and 26. GSM cell 26 has UMTS neighbors, that is, UMTS cell 20 is located in close relationship with GSM cell 26. At the point at which mobile station 16 enter Location Area LA₁, that is, at GSM cell 22, the mobile 16 performs Location Updating.

A UE leaving a LA which has UMTS neighboring cells, i.e. cells which are close to the GSM cells, will be informed at the next Location Area Update as to whether or not there are UMTS cells within the new LA. Optionally, the GSM network may download UMTS neighboring cell information to a mobile at Periodic Location Registration and IMSI attach/detach, which are well known procedures in GSM. The same procedure may also be used at Routing Area (“RA”) Update for packet switched connections.

In a second embodiment of the invention, the mobile receives from the network, upon entering a Location Area, a list of GSM cells that have UMTS neighbors. Most usefully, the GSM cell list will be valid for the Location Area and will consist of a subset of the cells belonging thereto. As with the preceding embodiment, this procedure is dedicated specifically to multimode mobiles stations, so that the list of UTMS neighboring cells is withheld from single mode mobiles. After pre-storing the list, the mobile station will proceed to move through the Location Area, as described above. As is known in the art, each of the GSM cells on the list will have an associated BCCH carrier. Accordingly, when the mobile is camping on one of the BCCH carriers from the list, the mobile station can search for UMTS neighbors with the same search pattern used for conventional GSM PLMN cell selection. Moreover, UEs with knowledge of the existence of UMTS neighbors, based on the pre-stored list of GSM cells that have UMTS neighbors, can perform Location Updating to receive additional UMTS neighboring cell information.

Further embodiments of the invention recognize that there exists spare bits on BCCH, e.g. in System Info 2bis or 2ter “rest octets”, that could be used without destroying the BCCH scheduling period. There are, of course, not enough spare bits to download the full UMTS neighboring cell information, i.e. the frequency and scrambling code combination therefor. However, several embodiments of the invention, as disclosed hereafter, respectively require only one or a few of the spare bits.

In one such embodiment, a mobile in a Location Area will have no information about UMTS cells, at a time that the mobile is being served by a GSM cell which has UMTS neighbors. The served mobile is thus camping on, or receiving, a BCCH carrier associated with the GSM cell. Accordingly, a single bit is downloaded to the mobile on the BCCH, to inform or provide notice to the mobile that the serving GSM cell has UMTS neighbors. The single bit thus serves as a flag. Upon reception of the flag, the mobile operates to send a downloading request message to the network. Upon reception of the request message, the network operates to download applicable/requested data to the mobile. Moreover, the mobile can use the flag to initiate LMTS measurements. It will be readily apparent that the flag can be dedicated, i.e., downloaded to multimode mobiles, but not to single mode mobiles.

In another embodiment which uses a small number of spare bits on BCCH, a multimode mobile, upon entering a Location Area, is provided with a BA-list of GSM cells in the Location Area. The 2ter “rest octets” of the BCCH is used to download a pointer to the GSM BA-list. The pointer indicates which GSM cells in the BA-list have UMTS neighbors. This is an alternative to use of MM specific procedures to indicate GSM cells with UMTS capable neighbors.

In yet another embodiment, it is recognized that intersystem cell reselection parameters need to be downloaded to a dual mode UE. Only a few bits are needed to broadcast these parameters. Accordingly, the parameter information may be broadcast on BCCH.

When a mobile station is camping on BCCH/PBCCH with no information about UMTS neighbors, the mobile or UE, in a further embodiment, uses a one bit flag to initiate UMTS measurements. Upon reception of the UMTS flag, the mobile may immediately start UMTS measurements according to the prestored list of UMTS neighbors in the LA. It may also use a pre-configured threshold to start measurement on UMTS. In case there is no information in the UE about UMTS cells, the mobile may either decide to perform normal Location Updating in order to get the UMTS neighboring cell information, or an initial UMTS cell selection. This procedure is likewise triggered by reception of the flag on BCCH/PBCCH. The mobile may use any pre-stored information about UMTS neighbors.

The Active Set is an optional feature in the cell. The mobile shall use this information, if received to select the Active Set. Every cell in the LA that has UMTS neighbors indicates to the UE (e.g. using spare bits in System Info2ter “rest octets”) which UMTS set is active. An active UMTS set consists of at least one UMTS cell with UMTS neighboring cell information to be used in the Intersystem cell selection procedure, or to be used at handover. The Active Set is a pure subset of the pre-stored list of UMTS neighboring cells. The pre-stored list of UMTS cell information is updated at Location Updating.

Obviously, other modifications and variations of the present invention are possible in light of the above teachings. It is therefore to be understood that within the scope of the disclosed concept, the invention may be practiced otherwise than as specifically described.

What is claimed is:

1. In a telecommunications network associated with a number of first cells in a location area, wherein each first cell is associated with a first communication system, wherein a given first cell has a neighboring second cell associated with a second communication system, and wherein both multimode and single mode mobile stations are disposed to enter and move through said location area into proximate relationship with said given first cell, a method for downloading information to a selected multimode mobile station comprising the steps of:
providing notice of said neighboring second cell to said selected mobile station when said selected mobile station enters said location area, and withholding said notice from any single mode mobile station entering said location area; and
operating said selected mobile station in response to said notice to acquire specified information pertaining to said second cell.

2. The method of claim 1 wherein:
said selected mobile station commences measurements directed to said second cell in response to said notice.

3. The method of claim 1 wherein:
said step of providing notice comprises transmitting a flag to said selected mobile station.

4. The method of claim 3 wherein:
said flag comprises a single bit transmitted to said selected mobile station by means of a BCCH carrier.

5. The method of claim 1 wherein:
said step of providing notice comprises downloading a list of first cells which respectively have second cell neighbors to said selected mobile station.

6. The method of claim 5 wherein:
said list is downloaded to said selected mobile station in connection with a Location Area Updating procedure commenced when said selected mobile station enters said location area.

7. The method of claim 1 wherein said step of providing notice comprises:
supplying a list of first cells in said location area to said selected mobile station; and
downloading a pointer to said selected mobile station to identify first cells on said list which respectively have neighboring second cells.

8. The method of claim 7 wherein:
said pointer is transmitted to said selected mobile station by means of a BCCH carrier.

9. The method of claim 1 wherein said step of providing notice comprises:
transmitting a flag to said selected mobile station to direct said selected mobile station to generate a download request message; and
downloading information pertaining to said second cell in response to said download request message.

10. The method of claim 1 wherein:
at least some of said specified information comprises intersystem cell reselection parameters which are downloaded to said selected mobile station by means of a MM specific procedure.

11. The method of claim 1 wherein:
said first communication system comprises the GSM, and said second communication system comprises the UTMS.

12. The method of claim 11 wherein:
at least some of said specified information comprises information needed by said selected mobile station to prepare for handover and cell reselection from said GSM system to said UTMS system.

13. The method of claim 1 wherein:
said network downloads a list of second cells in said location area to said mobile station during a location updating procedure.

14. The method of claim 1 wherein:
at least some of said specified information comprises frequency and scrambling code combinations for each second cell within said location area, each of said frequency and scrambling code combinations being downloaded to said mobile station by means of a MM specific procedure.
